(19) United States
(12) Patent Application Publication
(10) Pub. No.: US 2003/0010178 A1
(43) Pub. Date: Jan. 16, 2003

(54) Side lasher blade

(76) Inventors: Gary L. Trimpe, Preston, KS (US); Daryl A. Trimpe, Pratt, KS (US)

Correspondence Address: MCKEE, VOORHEES & SEASE, P.L.C., 801 GRAND AVENUE, SUITE 3200, DES MOINES, IA, 50309-2721, US

(21) Appl. No.: 09/904,803

(22) Filed: Jul. 13, 2001

(51) Int. Cl. B27B 33/12

(52) U.S. Cl. 83/840; 83/855

(57) ABSTRACT

An improved cutting blade is provided for cutting and thinning brush and small trees. The blade comprises a substantially circular disc having a plurality of removable, solid carbide cutters circumferentially spaced along the edge of the disc. A plurality of circular cavities are spaced circumferentially forwardly from each cutter to provide a radially extending opening for receiving and clearing saw chips away from the blade. The cutters are removably secured to the blade in cutter slots, having elongated linear openings extending rearwardly therefrom. A plurality of mounting bolts and receiving members extend perpendicularly through the linear openings from the edge of the blade for selectively compressing the cutter slots and securing the cutters. The design of the present invention decreases the incidence of blade jams and kick backs and increases the cutting efficiency and safety of the blade. The cutters are designed to be easily removed and sharpened or replaced at the job-site, decreasing “down time” and maintenance expenses.

### BACKGROUND OF THE INVENTION

1. Field of the Invention

The present invention relates to a side lasher blade for cutting brush, small trees, and other foliage, and more specifically, to a new and useful arrangement of removably securing cutting teeth to such a blade.

2. Description Of the Prior Art

Various types of cutting machines have been used for a number of years to trim and clear brush and small trees. These machines are typically comprised of mechanically driven blades that are mounted at the end of a support arm, or boom. Commonly, the booms are pivotally mounted on tractors or other types of vehicles. These cutting machines are operated along paths and roadways, in a more or less continuous manner, cutting and thinning brush and stands of trees.

Flail knives are used as the cutting blade in several prior art cutting machines. However, there are several drawbacks to the use of flail knives in these types of applications. The flail knife design requires the knives to rotate at a higher rate of speed than other cutting blades in order to cut through brush and small trees. This increases the cost and size of the saw motor used to operate the cutting blade. Flail knives are also inherently dangerous to operate. The rapidly flailing knives beat and tear into the wood, causing a substantial amount of debris to be thrown in uncontrolled directions, thus increasing the possibility of injury to people and their property.

Conventional rotary saw blades are also commonly found in prior art cutting machines. However, rotary saw blades tend to pull themselves along at uncontrolled speeds upon contact with the wood, frequently causing the blades to jam. Some prior art rotary blades are formed with a plurality of permanently fixed, offset teeth, much like a handsaw. These blades tend to be inefficient, slow cutting, and costly to sharpen. Clearly, an improved blade is needed to cut materials efficiently and quickly without jamming. Moreover, the teeth of the improved blade should be easy to sharpen and replace in the field.

Another common problem with the design of prior art rotary blades is their inability to discharge the wood chips and sawdust produced by the cutting action of the blade. As the wood chips accumulate, the blade will tend to bind and jam. This is a particular concern when cutting blades are used with guard casings, which can cause a considerable build-up of wood chips and sawdust. Therefore, an improved cutting tooth design is needed that will prevent the accumulation of wood chips and sawdust.

Some prior art rotary blades have been provided with teeth similar to those used in cutting chains for chain saws. Blades of this type are taught by U.S. Pat. Nos. 869,574; 1,988,898; 2,992,664; and 3,425,467. Other blades, such as those disclosed by U.S. Pat. Nos. 4,563,929 and 4,627,322, have lengths of saw chain secured along their periphery. However, a common problem with such blades is their tendency to “kick back,” that is, to give a sudden, forceful, and uncontrolled reaction that causes the blade and supporting elements to move suddenly away from the piece being cut. Such kick backs have caused many injuries. Accordingly, it is desirable that brush-cutting blades produce as little kick back force as possible to lessen the incidence of injury.

Some prior art blades have unsuccessfully attempted to address these several needs. U.S. Pat. No. 846,196 teaches a circular blade that removably receives a plurality of cutting teeth along its outer edge. Each tooth is placed in a void disposed in the outer edge of the blade. A wedge is then inserted into the void behind the tooth and a threaded bolt is disposed longitudinally through the wedge so that one end of the bolt engages the bottom surface of the void. As the bolt is turned deeper into the wedge, the wedge is raised with respect to the void and the tooth. The front surface of the wedge and the rear surface of the blade are opposably relieved so that, as the wedge is raised, transverse pressure is exerted on the tooth against the forward end of the void, thus securing the tooth within the void. While U.S. Pat. No. 846,196 teaches a blade having removable cutting teeth, it requires the use of several component pieces that must be separately fabricated and maintained, increasing cost, complexity, and incidence of “missing” or inoperable parts while in the field. Moreover, it fails to teach any means for preventing the accumulation of wood chips and sawdust.

U.S. Pat. No. 5,261,306 teaches a circular blade for cutting trees and brush, comprising a plurality of voids, circumferentially spaced along the outer edge of the blade, and removable cutting teeth that are positioned closely adjacent each void. This arrangement helps prevent the accumulation of wood chips along the edge of the cutting blade. However, the teeth must be individually tooled to receive threaded mounting bolts, which secure the teeth to the blade adjacent to a series of complex mounting and deflecting surfaces. Accordingly, an improved design for a cutting blade is needed to reduce the complexity and cost of manufacturing such cutting blades.

### SUMMARY OF THE INVENTION

A brush and tree cutting blade is provided, comprising a substantially circular disc having a plurality of removable, solid carbide cutters circumferentially spaced along the edge of the disc. The cutters are positioned with their cutting edges extending transversely of the disc. A plurality of circular cavities are provided along the edge of the blade, closely adjacent the cutters for receiving and clearing saw chips away from the blade.

Cutter slots, formed substantially in the shape of a cutter, are disposed closely adjacent the rearward side of each circular cavity. Each cutter slot is provided with an elongated, linear opening, which extends rearwardly therefrom and perpendicularly to the radii of the blade. The opposite end of the linear opening is provided with a circular opening, which prevents the blade from splitting along the longitudinal axis of the linear opening. A threaded mounting bolt is inserted into the edge of the blade and extends perpendicularly through the linear opening, toward the center of the blade. The end of the mounting bolt extends into a circular opening formed in the blade below the linear opening and is threadably received by a plugnut disposed within the circular opening. The bolt is tightened with respect to the plugnut to compress the cutter slot and linear opening. As the cutter slot compresses, its inner surfaces exert sufficient pressure on the sides of the cutter to secure it within the cutter slot.

The design of the present invention allows the blade to operate efficiently and smoothly. The blade uses a small number of widely spaced cutting teeth, which allows smaller engines to recover engine speed between each cutter, thus reducing engine labor. The cutters are slightly wider than the blade and beveled inwardly at the sides so that, as the cutters cut into the material, they create a kerf in which the blade freely rotates. Thus, the kerf and the chip slots cooperate to decrease the incidence of blade jams and kick backs, increasing the cutting efficiency and safety of the blade. The cutters are designed to be easily removed and sharpened or replaced at the job-site, decreasing “down time” and maintenance expenses. The cutters can also be provided in any number of lengths to allow the user to select the depth and speed at which the blade will cut into the material.

It is therefore a principal object of the present invention to provide an improved cutting blade which is configured to operate with increased efficiency and safety.

Another object of the invention is to provide an improved cutting blade that incorporates carbide cutters, which are releasably held in position along the edge of the blade.

Another object of the invention is to provide an improved cutting blade that provides for the easy replacement of worn or damaged cutters in the field to minimize down time.

A further object of the invention is to design an improved cutting blade that uses a small number of cutters to allow for the recovery of engine speed between each cutter and reduce engine labor.

A further object of the invention is to provide an improved cutting blade that incorporates openings in the edge of the blade that are adapted to help clear saw chips away from the blade.

Another object of the invention is to provide an improved cutting blade that is capable of taking cuts having selective depths.

Another object of the invention is to provide an improved cutting blade that is durable and economically manufactured.

Other objects and advantages of the invention will be apparent to those skilled in the art with reference to the accompanying drawings and descriptive matter.

### BRIEF DESCRIPTION OF THE DRAWINGS

FIG. 1 is a side elevational view of a preferred form of side lasher blade of the present invention;

FIG. 2 is a partial top plan view of a preferred form of the side lasher blade of the present invention;

FIG. 3A is a side elevational view of a preferred form of cutter employed in the side lasher blade illustrated in FIGS. 1 and 2;

FIG. 3B is a top plan view of the cutter illustrated in FIG. 3A;

FIG. 4 is an exploded top perspective view of a preferred form of cutter mounting assembly employed in the side lasher blade of the present invention;

FIG. 5 is a side elevational view of a preferred form of cutter mounting assembly employed in the side lasher blade of the present invention;

FIG. 6 is an exploded top perspective view of a preferred form of cutter mounting assembly employed in the side lasher blade of the present invention;

FIG. 7 is a side elevational view of an alternate embodiment of the cutter mounting assembly of FIG. 5.

FIG. 8 is a perspective view of a preferred form of cutter used with the cutter mounting assembly of FIG. 7.

### DESCRIPTION OF THE PREFERRED EMBODIMENT

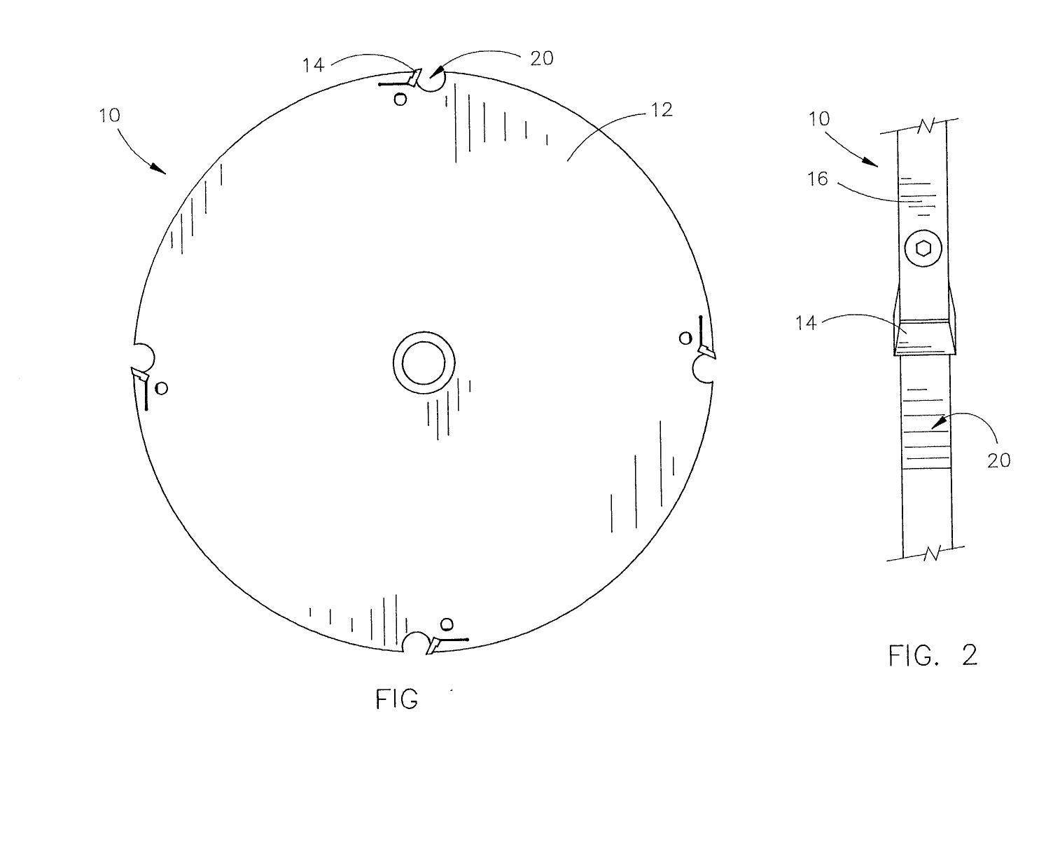

The numeral 10 refers generally to the side lasher blade of the present invention. As shown in FIGS. 1, 2 and 6, the blade 10 is comprised of a substantially circular disc 12 having a plurality of removable cutters 14 circumferentially spaced along the edge 16 of the disc 12. The cutters 14 are positioned with their cutting edges 18 extending transversely of the disc 12. A plurality of generally circular, radially extending, chip slots 20 are formed in the outer edge 16 of disc 12, closely adjacent the cutters 14 for receiving and clearing saw chips away from the blade 10.

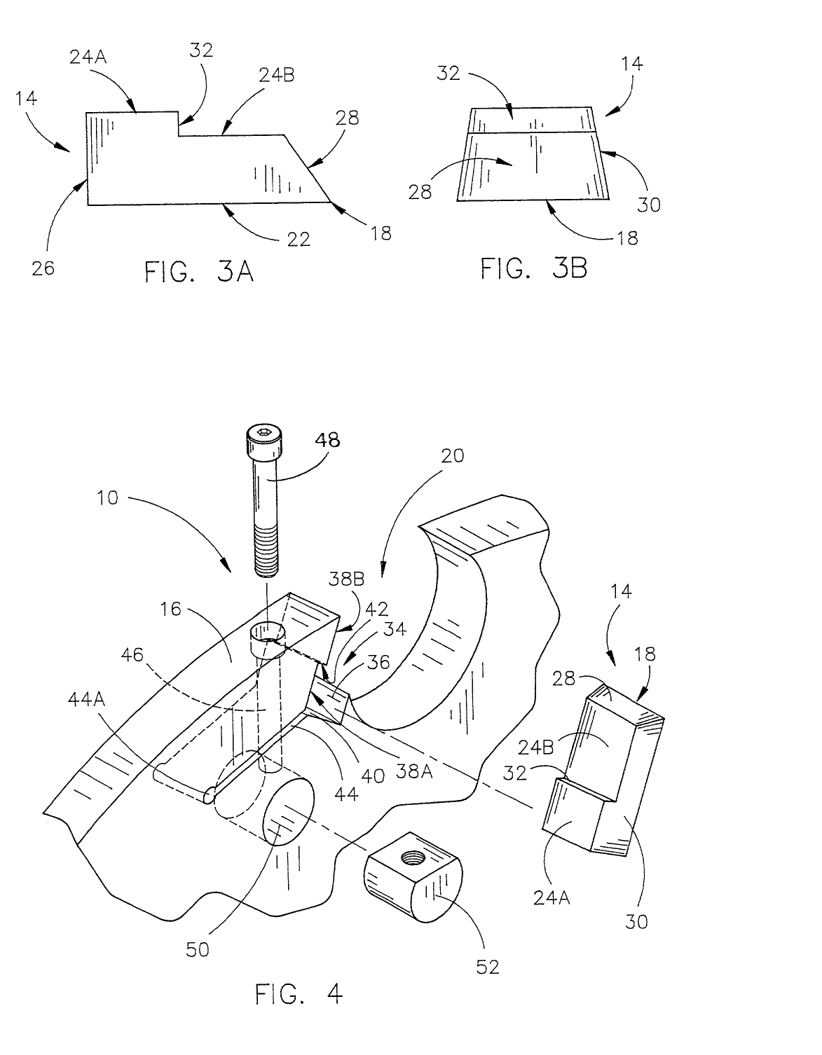

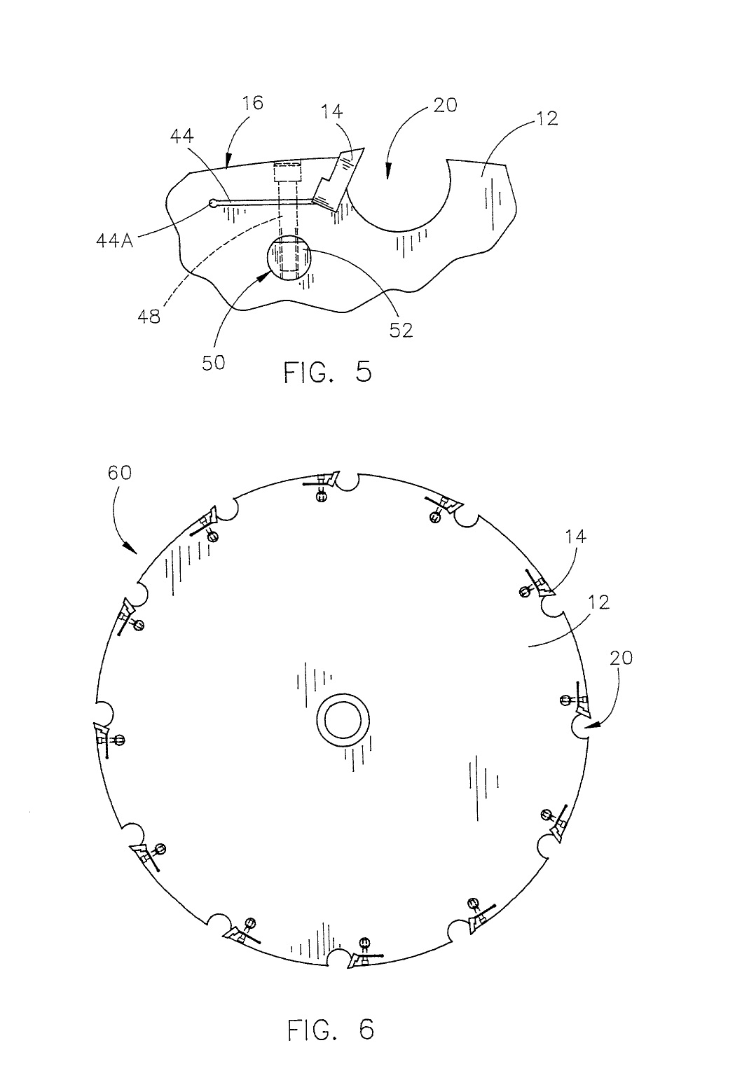

It is preferred that the cutters 14 be made from solid carbide, due to its strength and ability to be easily sharpened. However, it is contemplated that numerous other metals, including steel and titanium, could be used. As shown in FIGS. 3A, 3B and 4, the cutters are comprised of a substantially flat lower surface 22, upper surface 24 and rearward surface 26. Upper surface 24 is comprised of a first upper surface 24A and a separate but parallel second upper surface 24B. An upper joining surface 32 extends perpendicularly between the first upper surface 24A and the second upper surface 24B. The front surface 28 of cutter 14 extends upwardly and inwardly from lower surface 22, forming cutting edge 18. The cutter 14 is further provided with opposing sides 30, which extend upwardly and inwardly from lower surface 22.

A plurality of radially extending cutter slots 34 are formed in the outer edge 16 of the disc 12, closely adjacent chip slots 20. The cutter slots 34 are designed to removably receive the cutters 14. Accordingly, each cutter slot 34 is provided with inner surfaces that correspond in approximate shape and measurement to the shape of each cutter 14. For simplicity, the name of the individual inner surfaces of each cutter slot 34 is the same as its corresponding surface from each cutter 14. Therefore, the cutter slot inner surfaces are identified in FIG. 4 as: lower surface 36, upper surfaces 38A and 38B, rearward surface 40, and upper joining surface 42. The geometry created by lower surface 22, upper surface 24A, rearward surface 26, and upper joining surface 32 is generally square-shaped. The corresponding inner surfaces of the cutter slot 34 are also generally square in shape. Accordingly, once disposed within cutter slot 34, the cutter 14 is unable to exit the cutter slot 34 in a downward, upward, rearward, or forward direction. The cutter 14 can only be removed transversely from the cutter slot 34.

The cutter slots 34 are formed in the disc 12 so that the cutters 14 extend outwardly from the outer edge 16 of the disc 12 at an acute angle in the forward direction disc rotation. This angle squarely engages the cutting edge 18 with the surface of the material being cut. In a preferred embodiment, the cutters 14 are set at an angle approximately equal to twenty-five degrees from the diameter-line of disc 12. However, it is contemplated that the blade 10 could be formed to accommodate cutter angles from nearly zero to ninety degrees.

The blade 10 is provided with a plurality of mounting assemblies for firmly, but removably, securing the cutters 14 within the cutter slots 34. Each mounting assembly is comprised of a cutter slot 34, a generally elongated slot 44, an elongated first opening 46, a generally elongated mounting bolt 48, a second opening 50, and a plugnut 52. Elongated slot 44 comprises a narrow linear opening formed in disc 12, which extends rearwardly from, and perpendicularly to, the radii of blade 10. The first end of elongated slot 44 is in open communication with cutter slot 34. The second end of elongated slot 44 is formed into a generally circular opening 44A, which is slightly larger in diameter than the thickness of elongated slot 44. The generally circular shape helps opening 44A to resist the splitting of the blade 12 along the longitudinal axis of elongated slot 44 beyond the second end 44A. The mounting assembly is essentially comprised of an elongated opening that extends from opening 44A, through elongated slot 44, and through cutter slot 34. The length of this elongated opening allows the elongated slot 44 and the cutter slot 34 to be selectively, elastically compressible. Accordingly, when downward pressure is applied to the outer edge 16 of disc 12, cutter slot 34, and to a certain extent elongated slot 44, will compress inwardly. The compression causes the inner surfaces of cutter slot 34 to firmly engage the surfaces of cutter 14, preventing the transverse movement of cutter 14.

An elongated first opening 46, having first and second ends, is formed in the outer edge 16 of disc 12 and extends generally perpendicularly through elongated slot 44. A generally elongated mounting bolt 48 is provided, having first and second ends. In the figures, mounting bolt 48 is a socket head capscrew. However, it is contemplated that nearly any threaded bolt of an appropriate diameter will work. The elongated first opening 46 is provided with a sufficient diameter to receive mounting bolt 48 and allow it to pass perpendicularly through elongated slot 44 and into a second opening 50, formed in disc 12 below elongated slot 44. Accordingly, the second opening 50 is in open communication with elongated first opening 46. A plugnut 52 is adapted to be removably received by second opening 50. Plugnut 52 is further adapted to selectively adjustably receive the second end of the mounting bolt 48. As the mounting bolt 48 is threadably engaged with plugnut 52 and tightened accordingly, the cutter slot 34 compresses about cutter 14 to firmly secure the same within the mounting assembly. It is contemplated however, that the mounting assembly could be provided without second opening 50 or plugnut 52. In such an embodiment it will be important that the second end of first opening 46, positioned radially inwardly of elongated slot 44, be formed with threads or other structure to selectively, adjustably receive the second end of mounting bolt 48 so that, as mounting bolt 48 is tightly secured within first opening 46, cutter slot 34 compresses about cutter 14.

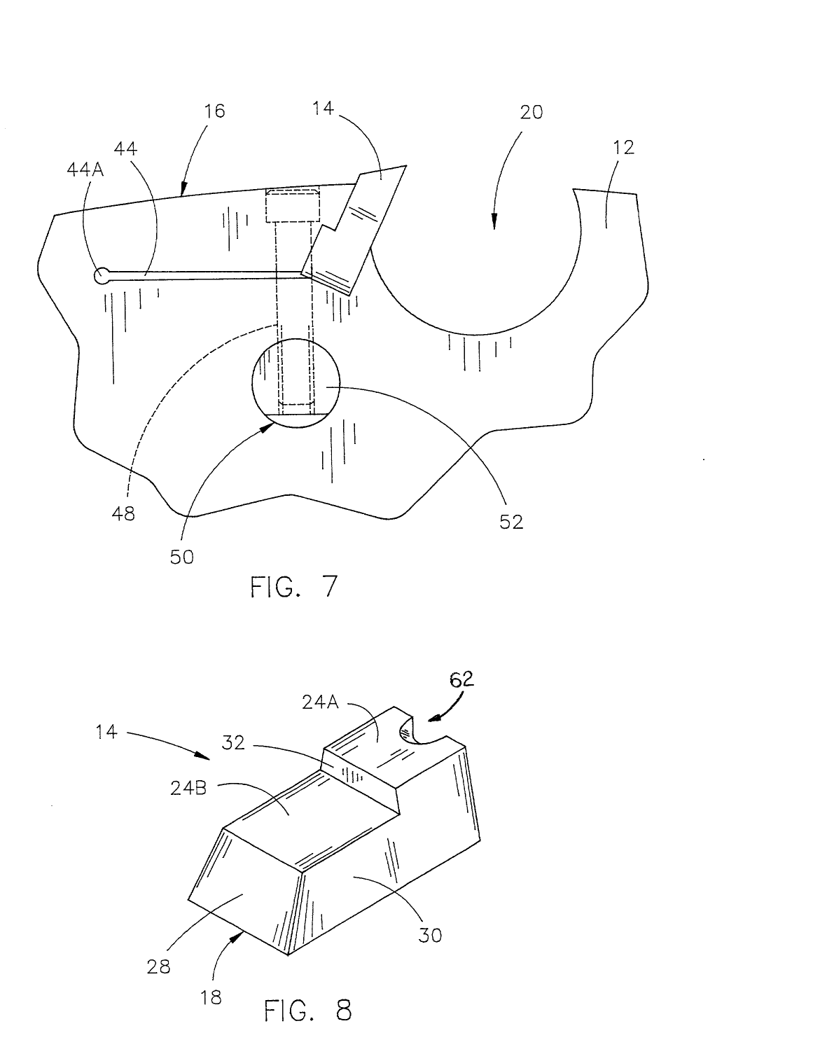

In an alternate embodiment, illustrated by FIGS. 7 and 8, elongated first opening 46 can be positioned so that it is in open communication with elongated slot 44 and cutter slot 34. In this embodiment, it will be necessary to form a groove 62 in the rearward end of cutter 14. Groove 62 preferably extends between upper surface 24A and rearward surface 26 so that it at least partially operatively receives mounting bolt 48, as mounting bolt 48 is disposed within first opening 46. Positioning the first opening 46 in open communication with the cutter slot 34 allows for a greater and more direct compression force to be exerted about cutter 14 as mounting bolt 48 is tightened within blade 10. Moreover, disposing mounting bolt 48 at least partially through groove 62 allows for additional lateral stability of the cutter 14 within cutter slot 34.

The design of blade 10 allows it to operate efficiently and safely, thus improving the prior art designs. In its preferred embodiment, the blade 10 uses a small number of widely spaced cutters 14. It is contemplated that the design would function with as few as one cutter 14 and as many cutters 14 the circumference of the chosen disc size can reasonably accommodate, such as the blade 60 illustrated in FIG. 6. However, using a smaller number of cutters 14, as illustrated in FIG. 1, will allow smaller engines to recover engine speed between each cutter 14, thus reducing engine labor and maintaining an even and efficient cutting speed.

The cutters 14 are constructed to be slightly wider than the disc 12 and have inwardly beveled sides 30 so that, as the cutters cut into the wood, or similar material, they create a kerf in which the blade freely rotates. Accordingly, the cutters 14 and chip slots 20 cooperate to effectively decrease the incidence of blade jams and kick backs, thus increasing the overall cutting efficiency and safety of the blade 10. The cutters 14 are also designed to be easily removed from the blade 10. Therefore, if one or more cutters 14 become dull or broken in the field, they can either be sharpened or replaced without leaving the job-site. This has proven to dramatically decrease the customary “down time” and maintenance expenses associated with dull or broken cutting teeth on other cutting blades.

The cutters can also be provided in any number of lengths to allow the user to select the depth and speed at which the blade will cut into the material. The cutters 14 are disposed within the cutter slots 34 so that a select amount of the cutter 14 and its cutting edge 18 extends beyond the outer edge 16 of blade 12. Accordingly, when four cutters 14 are inserted into the cutter slots 34 with an exposed cutting surface of ⅛ of an inch, one complete pass of the blade 12 against a tree should render a cut that is not deeper or more shallow than ½ of an inch. Therefore, the blade 10 is self-regulating. The depth and speed of the cuts can easily be changed by replacing the cutters being used for ones that are longer or shorter.

In the drawings and in the specification, there has been set forth preferred embodiments of the invention and although specific items are employed, these are used in a generic and descriptive sense only and not for purposes of limitation. Changes in the form and proportion of parts, as well as a substitution of equivalents, are contemplated as circumstances may suggest or render expedient without departing from the spirit or scope of the invention as further defined in the following claims.

Thus it can be seen that the invention accomplishes at least all of its stated objectives.

We claim:

1. A cutting blade for cutting and thinning brush and trees, comprising:
a substantially circular disc, having an outer edge and opposing side surfaces; said disc being rotatable in an operative forward direction about an axis of rotation extending transversely through the center of said disc;
a plurality of circumferentially spaced, radially extending, chip slots formed in the outer edge of said disc;
a plurality of radially extending cutter slots formed in the outer edge of said disc in communication with said chip slots; said cutter slots each having at least one pair of opposing inner surfaces; said pair of opposing inner surfaces being adapted to receive a cutter therebetween;
a plurality of generally elongated cutters, having upper, lower, rearward, and forward surfaces, and a cutting edge closely adjacent said lower and forward surfaces; said cutting edge being positioned to describe an arc during rotation of the blade about said axis of rotation; and
a plurality of mounting means for removably securing said cutters within said cutter slots.

2. The cutting blade of claim 1 wherein the opposing inner surfaces of said cutter slots are substantially parallel to one another.

3. The cutting blade of claim 2 wherein said cutter slots have substantially parallel upper and lower inner surfaces, and substantially parallel forward and rearward inner surfaces.

4. The cutting blade of claim 1 wherein said cutters have substantially parallel upper and lower surfaces, a rear surface extending generally perpendicularly between said upper and lower surfaces, and a front surface extending upwardly and inwardly from said lower surface.

5. The cutting blade of claim 4 wherein the upper surface of said cutters are comprised of a first upper surface, having first and second edges, and a separate but parallel second upper surface, having first and second edges.

6. The cutting blade of claim 5 wherein said cutters further comprise an upper joining surface operatively connecting the second end of said first upper surface and the first end of said second upper surface; said upper joining surface being generally perpendicular with respect to said first and second upper surfaces.

7. The cutting blade of claim 1 wherein said cutters extend outwardly from the edge of said disc at a generally acute angle in the forward direction disc rotation.

8. The cutting blade of claim 1 wherein said cutters have a width greater than the distance between the opposing side surfaces of said disc.

9. The cutting blade of claim 8 wherein said cutters are adapted to cut a kerf in which the disc may freely rotate.

10. The cutting blade of claim 9 wherein said cutters are further provided with opposing side surfaces; said opposing side surfaces extending generally upwardly and inwardly from said bottom surface.

11. The cutting blade of claim 1 wherein said cutters are comprised of solid carbide.

12. The cutting blade of claim 1 wherein said mounting means is comprised of a selectively compressible, generally elongated slot, having first and second ends; said first end of said elongated slot being in communication with a cutter slot.

13. The cutting blade of claim 12 wherein the second end of said elongated slot is adapted to resist the splitting of the blade along the longitudinal axis of said elongated slot beyond said second end.

14. The cutting blade of claim 13 wherein said mounting means is further comprised of an elongated first opening, having first and second ends, formed in the edge of said disc and extending generally perpendicularly through and in communication with said elongated slot.

15. The cutting blade of claim 14 wherein said mounting means is further comprised of a generally elongated mounting bolt, having first and second ends; said elongated first opening being adapted to operatively receive said mounting bolt.

16. The cutting blade of claim 15 wherein said second end of said mounting bolt being adapted to be selectively secured within said disc to compress said cutter slot and secure a cutter therein.

17. The cutting blade of claim 15 wherein said mounting means is further comprised of a second opening formed in said disc radially inwardly of said elongated slot; said second opening being in communication with the second end of said elongated first opening.

18. The cutting blade of claim 17 wherein said mounting means is further comprised of a plugnut; said plugnut being adapted to be received by said second opening; said plugnut being further adapted to selectively adjustably operatively receive the second end of said mounting bolt to compress said cutter slot and secure the cutter therein.

19. The cutting blade of claim 18 wherein said first opening is in communication with said elongated slot and said cutter slot.

20. The cutting blade of claim 19 wherein said cutters have upper and lower surfaces, a rear surface extending between said upper and lower surfaces, and a groove extending between the upper and rear surfaces; said groove being adapted to at least partially receive said mounting bolt.

21. A circular cutting blade, comprising:
a substantially circular disc, having an outer edge and opposing side surfaces; said disc being rotatable in an operative forward direction about an axis of rotation extending transversely through the center of said disc;
at least one radially extending chip slot formed in the outer edge of said disc;
at least one radially extending cutter slot formed in the outer edge of said disc closely adjacent said at least one chip slot; said at least one cutter slot having at least one pair of opposing inner surfaces; said pair of opposing inner surfaces being adapted to receive a cutter therebetween;
at least one generally elongated cutter, having upper, lower, rearward, and forward surfaces, and a cutting edge closely adjacent said lower and forward surfaces; said cutting edge being positioned to describe an arc during rotation of the blade about said axis of rotation; and
mounting means for removably securing said at least one cutter within said at least one cutter slot.

22. A circular cutting blade, comprising:
a substantially circular disc, having an outer edge and opposing side surfaces; said disc being rotatable in an operative forward direction about an axis of rotation extending transversely through the center of said disc;
means for transporting saw chips away from the blade being formed in the outer edge of said disc;
means for removably securing a cutter adjacent said saw chip transporting means;
at least one generally elongated cutter, having first and second ends and a cutting edge closely adjacent said first end; said cutting edge being positioned to describe an arc during rotation of the blade about said axis of rotation.
